(19) United States
(12) Patent Application Publication
(10) Pub. No.: US 2015/0159996 A1
(43) Pub. Date: Jun. 11, 2015

(54) MEASURING METHOD OF UTILIZATION DEPTH OF ACTIVE MATERIAL, MANUFACTURING METHOD OF LITHIUM SECONDARY BATTERY, AND THE LITHIUM SECONDARY BATTERY

(71) Applicant: SEIKO EPSON CORPORATION, Tokyo (JP)

(72) Inventors: Sukenori ICHIKAWA, Suwa-shi (JP); Yasuto KAKEMURA, Chino-shi (JP)

(21) Appl. No.: 14/561,865

(22) Filed: Dec. 5, 2014

(30) Foreign Application Priority Data
Dec. 9, 2013 (JP) 2013-254540

(51) Int. Cl. G01B 11/06; H01M 10/058; G01B 11/22; H01M 10/052

(52) U.S. Cl. CPC G01B 11/06; H01M 10/052; H01M 10/058; G01B 11/22; G01J 3/44

(57) ABSTRACT

A lithium secondary battery active material body is cut in a direction from a positive electrode to a negative electrode, a section is exposed, the section is smoothed, a Raman spectroscopic analysis is performed on the smooth section, and an utilization depth of active material of the lithium secondary battery active material body is measured.

### CROSS-REFERENCE TO RELATED APPLICATION

This application claims a priority to Japanese Patent Application No. 2013-254540 filed on Dec. 9, 2013 which is hereby expressly incorporated by reference in its entirety.

### BACKGROUND

1. Technical Field

Several aspects of the present invention relate to a measuring method of utilization depth of active material, a manufacturing method of a lithium secondary battery, and the lithium secondary battery.

2. Related Art

A lithium secondary battery using lithium (metal lithium) or lithium-containing material (for example, lithium compound such as lithium complex oxide) as a negative electrode has light weight and large capacity, and further can obtain high voltage by combination with a suitable positive electrode active material. Thus, the lithium secondary battery is widely used for a portable electronic equipment, a camera, a watch, an electric tool, a hybrid vehicle battery, etc.

In order to further improve the volume capacity density (volume energy density) as a secondary battery, a nonaqueous electrolyte secondary battery is developed in which a positive electrode active material body is formed by press molding and sintering, in which the filling density of active material is high (see, for example, JP-A-8-180904 (Patent Literature 1)).

However, when the molded body obtained by the press molding and sintering is used as the molded body of the active material of the lithium secondary battery, the ratio of the active material contributing to charging and discharging significantly depends on the transmission distance of lithium ions diffusing in the molded body and the transmission distance of lithium ions in an electrolyte (for example, electrolytic solution). For example, FIG. 6 shows an example of a lithium secondary battery 100 in which a positive electrode 101 includes an active material molded body 104 and a positive electrode current collector 105, a separator 103 is provided between the positive electrode current collector 105 and a negative electrode 102, and an electrolytic solution 106 is filled. At the time of discharge of the lithium secondary battery, when an electron (e⁻) flows from the negative electrode to an external circuit, a lithium ion (Li⁺) moves from the negative electrode to the positive electrode in the lithium secondary battery.

The transmission distance of lithium ions diffusing in the active material molded body 104 is controlled by the diffusion coefficient of lithium ions in active material crystal grains 107 constituting the active material molded body 104, the transfer resistance of lithium ions at a contact interface between the active material crystal grains 107, and the like. The diffusion coefficient, the transfer resistance and the like are changed according to the size of the active material crystal grain, the degree of sintering and the like. The transmission distance of lithium ions in the electrolytic solution 106 is changed according to the volume and shape of a gap between the active material crystal grains 107 in the active material molded body 104 in addition to the volume resistivity of the electrolytic solution.

When the volume resistivity of the electrolytic solution is low like a general-purpose organic electrolytic solution, the transmission distance of lithium ions in the electrolytic solution is longer than the transmission distance of lithium ions diffusing in the active material molded body. In this case, the active material in a region larger than the transmission distance of lithium ions diffusing in the active material molded body is used for charging and discharging. That is, the amount of the active material contributing to charging and discharging is large.

However, when the volume resistivity of an electrolyte is high like an ionic liquid electrolyte or a solid electrolyte, the transmission distance of lithium ions in the electrolyte becomes short and the amount of active material contributing to charging and discharging is reduced.

### SUMMARY

An advantage of some aspects of the invention is to provide a method of measuring utilization depth of active material by visualizing a distribution of active material contributing to charging and discharging in a lithium secondary battery active material body. Besides, an advantage of some aspects of the invention is to provide a manufacturing method of a lithium secondary battery and the lithium secondary battery, in which the size and thickness of a lithium secondary battery active material body is regulated based on the utilization depth of active material and the use efficiency of the lithium secondary battery active material body in charging and discharging is improved.

A measuring method of utilization depth of active material according to an aspect of the invention includes cutting a lithium secondary battery active material body in a direction from a positive electrode to a negative electrode, exposing a section, smoothing the section, performing a Raman spectroscopic analysis on the smooth section, and measuring the utilization depth of active material of the lithium secondary battery active material body.

According to this configuration, the utilization depth of active material of the lithium secondary battery active material body can be measured by performing the Raman spectroscopic analysis on the smooth section exposed in the direction from the positive electrode to the negative electrode. Accordingly, a region where the degree of contribution to charging and discharging is high can be identified. By this, the thickness and shape of the active material body can be efficiently regulated.

In the measuring method of the utilization depth of active material, it is preferable that the Raman spectroscopic analysis is performed at plural positions of the smooth section to obtain a distribution of active material in a charging state or a discharging state, and the utilization depth of active material is measured from the distribution.

According to this configuration, the distribution of the active material can be visualized by obtaining the distribution of the active material in the charging state or the discharging state at the plural positions of the smooth section.

In the measuring method of the utilization depth of active material, it is preferable that a smoothness of the smooth section is Ra<0.9 μm.

According to this configuration, a sufficient scattering intensity can be secured in the Raman spectroscopic analysis.

In the measuring method of the utilization depth of active material, it is preferable that discrimination of the active material in the charging state or the discharging state is performed by a shift of a Raman scattering peak.

According to this configuration, in the Raman spectroscopic analysis, an influence due to the height difference of the section is reduced as compared with a case where the discrimination of the active material is performed by the intensity of the Raman scattering peak.

A manufacturing method of a lithium secondary battery according to another aspect of the invention includes measuring an utilization depth of active material of a lithium secondary battery active material body by the above measuring method of the utilization depth of active material, and forming the lithium secondary battery active material body including active material with a depth required for a function as the active material.

According to this configuration, since the utilization depth of active material of the lithium secondary battery active material body is measured by the measuring method of the utilization depth of active material, and the lithium secondary battery active material body including the active material with the depth required for the function as the active material is formed. Accordingly, since the ratio of the active material contributing to charging and discharging in the lithium secondary battery active material body becomes high (equal to or close to 100%), the volume capacity density of the lithium secondary battery can be improved.

A lithium secondary battery according to still another aspect of the invention is manufactured by the manufacturing method of the lithium secondary battery.

According to this configuration, since the ratio of the active material contributing to charging and discharging in the lithium secondary battery active material body is high (equal to or close to 100%), the lithium secondary battery having a high volume capacity density can be obtained.

### BRIEF DESCRIPTION OF THE DRAWINGS

The invention will be described with reference to the accompanying drawings, wherein like numbers reference like elements.

FIG. 1 is a sectional view showing an example of a lithium secondary battery.

FIGS. 2A and 2B are explanatory views exemplifying a sample manufacturing method of a lithium secondary battery active material body.

FIG. 3 is a graph showing an example of a measurement spectrum by Raman spectroscopic measurement.

FIGS. 4A and 4B are schematic views showing an example of a change in measurement spectrum caused by a difference in a charging state or a discharging state.

FIGS. 5A and 5B are views showing an example of discrimination and distribution of active material in a charging state or a discharging state.

FIG. 6 is a sectional view showing an example of an operation state of a lithium secondary battery.

### DESCRIPTION OF EXEMPLARY EMBODIMENTS

Hereinafter, the invention will be described on the basis of embodiments and with reference to the drawings.

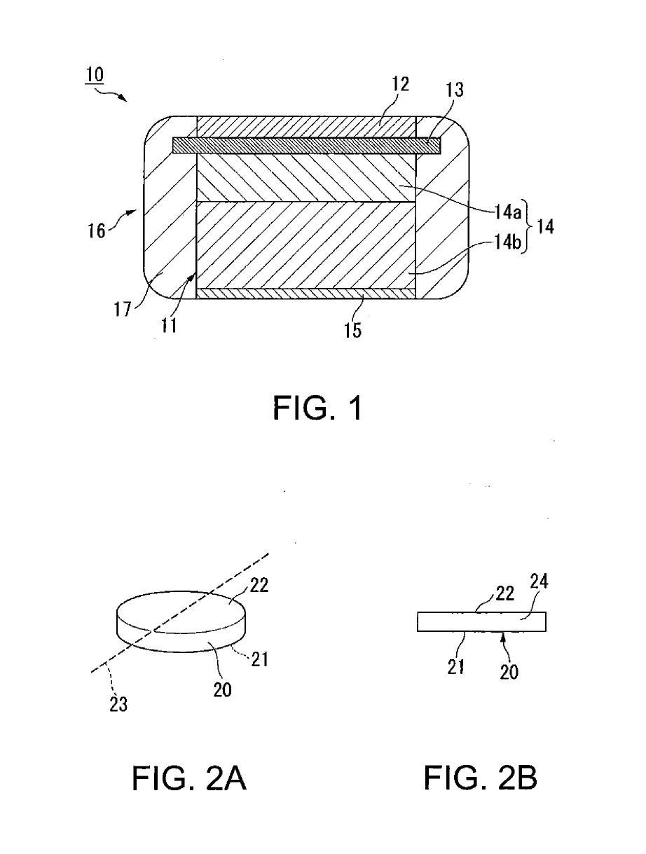

FIG. 1 is a sectional view showing an example of a lithium secondary battery. The lithium secondary battery 10 includes, as a power generation element 16, a positive electrode 11, a negative electrode 12 and a separator 13. The positive electrode 11 includes a positive electrode active material body 14 and a positive electrode current collector 15. In the specification, a “lithium secondary battery active material body” is an active material body used in the lithium secondary battery. In the example shown in FIG. 1, the lithium secondary battery active material body is the positive electrode active material body 14.

The positive electrode active material body 14 includes a positive electrode active material and is a material body shaped into a specified shape. As the positive electrode active material, a lithium-containing material such as lithium complex oxide is cited. In the specification, the “lithium complex oxide” is an oxide which always includes lithium and includes two or more kinds of metal ions as a whole and in which an oxo acid ion does not exist. As the lithium-containing material, for example, LiCoO₂, LiMn₂O₄, LiMnO₂, Li₂Mn₂O₃, LiCo₁₋ₓNiₓO₂, LiNiO₂, LiFePO₄, Li₂FeP₂O₇, LiMnPO₄, LiFeBO₃, Li₃V₂ (PO₄)₃, Li₂CuO₂, LiFeF₃, Li₂FeSiO₄, Li₂MnSiO₄, etc. are enumerated. Only one kind of the positive electrode active material may be used in the positive electrode active material body, or a solid solution or a mixture of two or more kinds of the positive electrode active materials may be used.

The positive electrode active material body 14 may substantially contain only the positive electrode active material or may contain a material other than the positive electrode active material, for example, a solid electrolyte. As an inorganic solid electrolyte which may be contained in the positive electrode active material, various ones enumerated below can be used.
(1) Inorganic crystal, inorganic glass or partially crystallized glass having lithium ion conductivity
(2) NASICON-type ceramic crystal such as LiTi₂(PO₄)₃, Li_{1.3}M_{0.3}Ti_{1.7}(PO₄)₃ (where, M=Al, Sc)
(3) perovskite-type ceramic crystal such as Li_{0.35}La_{0.55}TiO₃, LiSr₂TiTaO₆ or Li₃ₓLa_{1/3-x}TaO₃
(4) thio-LISICON crystal such as Li₄₋ₓSi₁₋ₓPₓS₄ or Li₄₋ₓGe₁₋ₓPₓS₄
(5) LISICON crystal such as Li₁₄Zn(GeO₄)₄
(6) Li-doped β-Al₂O₃ crystal
(7) partially crystallized glass containing the above crystal
(8) sulfide glass such as Li₂S—SiS₂—LiPO₃ system or Li₂S—P₂S₅ system
(9) oxide glass such as Li₂O—SiO₂—B₂O₃ system or Li₂O—SiO₂—ZrO₂ system
(10) LIPON glass (see, for example, JP-A-2004-179158)
(11) LiI crystal
(12) Li₃PO₄ crystal
(13) garnet-type ceramic crystal such as Li₇La₃Zr₂O₁₂

A step of forming the positive electrode active material into a specified shape includes one or more steps selected appropriately from various processing steps such as press molding, pellet molding, cutting and polishing. When the positive electrode active material body is formed by sintering the molded body of the positive electrode active material formed into the specified shape, the molded body before sintering may include one or more kinds of additives such as binder, conductive filler and insulation particle. The binder is burned or oxidized in the sintering process and the amount thereof is reduced or becomes zero.

The positive electrode current collector 15 is made of a conductive thin plate member or foil member of Cu, Ni, Ti, Al, stainless, carbon, etc. Besides, the positive electrode current collector is connected with a positive electrode wiring (not shown).

The negative electrode 12 is made of metal lithium, lithium alloy, metal indium, graphite, carbon or the like. The negative electrode can include a negative electrode active material such as lithium titanate (Li₄Ti₅O₁₂). Further, the negative electrode may include a negative electrode current collector (not shown) formed of a conductive thin plate or foil member of Cu, Ni, Ti, Al, stainless, carbon or the like. The negative electrode or the negative electrode current collector is connected with a negative electrode wiring (not shown).

An electrolyte can also be used in the lithium secondary battery. As the electrolyte, an organic electrolyte, a solid electrolyte, a gel electrolyte, a polymer electrolyte, etc. can be enumerated.

The separator 13 is provided in order to prevent short-circuit between the positive electrode 11 and the negative electrode 12 if necessary. The separator has a material or a structure through which lithium ions can pass. For example, a microporous membrane of polyolefin or the like, a solid electrolyte layer or the like can be used as the separator.

The power generation element 16 is contained in a container. A medium (or atmosphere) 17 in the container may be a gas, a liquid, a solid or a mixture of these. When an electrolytic solution is filled as the medium 17, the separator is preferably fixed to a side wall of the container. When the electrolyte used in the lithium secondary battery is a solid electrolyte, the atmosphere 17 may be a gas such as an inert gas. The solid electrolyte layer can be used also as the separator, and in that case, the microporous membrane is not required.

As described above, the transmission distance of lithium ions in the lithium secondary battery significantly depends on the transmission distance of lithium ions diffusing in the lithium secondary battery active material body and the transmission distance of lithium ions in the electrolyte (for example, electrolytic solution) around the lithium secondary battery active material body. The transmission distance of lithium ions diffusing in the lithium secondary battery active material body is controlled by the diffusion coefficient of lithium ions in active material crystal grains constituting the lithium secondary battery active material body, the transfer resistance of lithium ions at a contact interface between the active material crystal grains, and the like. The diffusion coefficient, the transfer resistance and the like are changed according to the size of the active material crystal grain, the degree of sintering and the like. The transmission distance of lithium ions in the electrolytic solution is changed according to the volume and shape of a gap part between the active material crystal grains in the lithium secondary battery active material body in addition to the volume resistivity of the electrolytic solution.

Thus, in the lithium secondary battery active material body, since the transmission distance of lithium ions is limited, an utilization depth of active material required for the function as the active material can be regulated. For example, in the case of the positive electrode active material body 14, a contributing part 14a contributing to charging and discharging exists in a region where the distance from the negative electrode 12 side (distance from the separator 13 in FIG. 1) is short, and a non-contributing part 14b not contributing to charging and discharging can exist in a region where the distance from the negative electrode 12 side is long. In the case of the negative electrode active material body, a contributing part contributing to charging and discharging exists in a region where the distance from the positive electrode side is short, and a non-contributing part not contributing to charging and discharging can exist in a region where the distance from the positive electrode side is long. The utilization depth of active material corresponds to the thickness of the contributing part.

When the ratio of the non-contributing part in the lithium secondary battery active material body is large, the active material contributing to charging and discharging is reduced, and the volume capacity density of the lithium secondary battery is reduced. Then, if the utilization depth of active material is previously known, the volume capacity density can be improved by forming the lithium secondary battery active material body including the active material with the required depth and by using it in the lithium secondary battery.

At the time of discharging of the lithium secondary battery, when an electron flows from the negative electrode to an external circuit, lithium moves from the negative electrode to the positive electrode in the lithium secondary battery. On the contrary, at the time of charging of the lithium secondary battery, lithium moves from the positive electrode to the negative electrode in the lithium secondary battery. Then, if the increase and decrease of lithium in the lithium secondary battery active material body is recognized, the contributing part contributing to charging and discharging can be specified. Besides, if the thickness of the contributing part is known, the utilization depth of active material can be measured.

When the increase or decrease of lithium occurs in the lithium secondary battery active material body, the crystal structure of the active material is changed. In the invention, Raman spectroscopic analysis is used in order to observe the change of the crystal structure of the active material caused by charging and discharging.

The Raman spectroscopic analysis is a spectroscopic analysis performed by observing a Raman spectrum caused by the vibration of atoms in a molecule or crystal. In order to vibrate the atoms, a laser light is used as an exciting light source. The Raman spectrum can be locally observed by condensing the laser light through a lens.

The change of the local Raman spectrum is observed, so that it can be determined whether the active material existing at the position contributes to charging and discharging. The observation of the Raman spectrum is scanned in a direction crossing the positive electrode and the negative electrode, and the position information of the active material contributing to charging and discharging is collected. As a result, the region contributing to charging and discharging, that is, the contributing part can be specified. Further, the utilization depth of active material is obtained as the thickness of the contributing part.

FIGS. 2A and 2B are explanatory views exemplifying a sample manufacturing method of a lithium secondary battery active material body. A sample used in the Raman spectroscopic analysis can be formed such that for example, as shown in FIG. 2A, a suitably shaped lithium secondary battery active material body 20 is prepared, the lithium secondary battery active material body 20 is cut along a specified cutting direction 23, and a section 24 is exposed as shown in FIG. 2B. The cutting direction 23 is the direction from the positive electrode to the negative electrode. The sequence of cutting is not particularly limited, and the cutting may be started from the positive electrode side to the negative electrode side. Besides, the cutting may be started from the negative electrode side to the positive electrode side, or the cutting may be started from another side (for example, a side surface).

The lithium secondary battery active material body 20 used for the formation of the sample preferably includes a positive electrode side end face 21 and a negative electrode side end face 22 so that the direction crossing the positive electrode and the negative electrode is specified when used for the lithium secondary battery. The positive electrode side end face 21 and the negative electrode side end face 22 are preferably surfaces parallel to each other. In the lithium secondary battery active material body, when the direction crossing the positive electrode and the negative electrode can be arbitrarily set, for example, when the distribution of active material and gaps is not anisotropic but is isotropic, the two end faces 21 and 22 can be formed at arbitrary positions.

The section 24 of the lithium secondary battery active material body 20 is required to be a smooth section so that the Raman spectroscopic analysis can be performed at plural positions along the direction crossing the positive electrode and the negative electrode. As a method of smoothing the cut section, for example, ion milling polishing is cited. The ion milling polishing is a method of polishing a surface by irradiating an ion beam of argon (Ar) ions or the like to the surface of a sample.

The smoothness of the smooth section is preferably Ra<0.9 μm, more preferably Ra≦0.4 μm, and still more preferably Ra<0.2 μm.

When the refractivity of the medium is n, the wavelength of measurement light is λ, and the numerical aperture of a lens is NA, the focal depth d of the objective lens is (n×λ)/(2×NA2). For example, when the refractivity n of the medium is 1, the laser wavelength λ is about 500-600 nm, and the numerical aperture NA is about 0.5, the focal depth d is 0.9-1.2 μm. Thus, if the smoothness is Ra<0.9 μm, the influence of the surface roughness of the section on the measurement of the Raman spectroscopic analysis can be suppressed. When the lens has a magnification of 50 and a numerical aperture NA of about 0.85 μm, the focal depth is about 400 nm (that is, 0.4 μm). Thus, Ra is preferably 0.4 μm or less.

A cut-off value λc of a filter for obtaining a roughness curve is preferably, for example, λc<0.25 mm. The smoothness Ra is the arithmetic average height (arithmetic average roughness) of the roughness curve.

When the magnification of the objective lens is 100×, the smoothness is preferably, for example, Ra<0.2 μm, and the cut-off value is preferably λc<0.03 mm (that is, λc<30 μm).

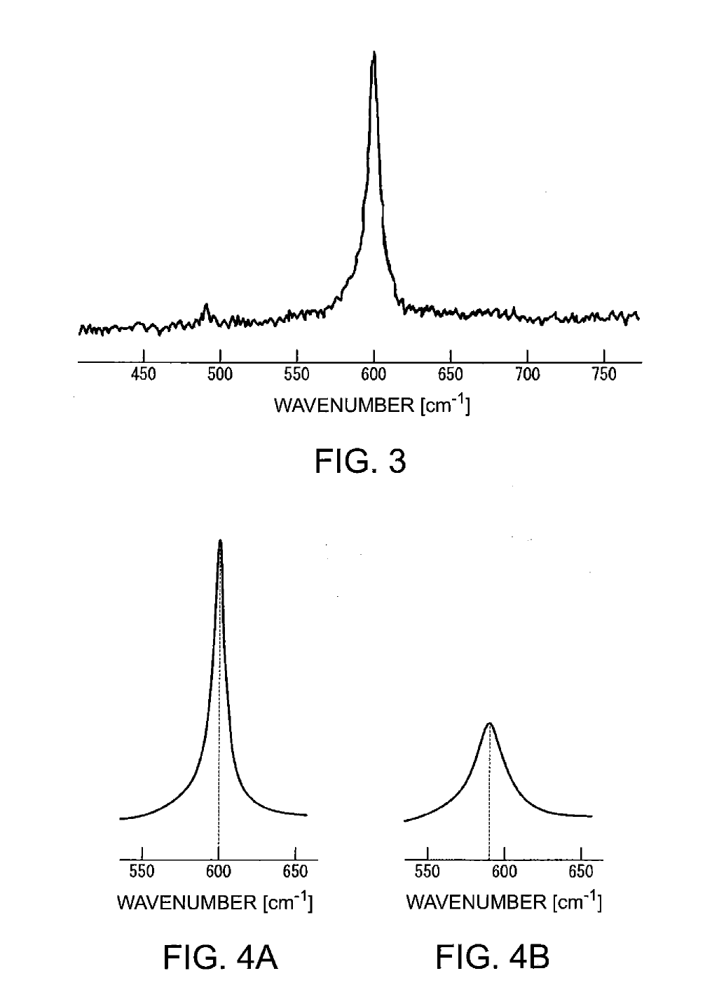

FIG. 3 shows an example of results of measurement of the Raman spectrum of LiCoO₂ by the Raman spectroscopic measurement. An argon ion (Ar⁺) laser of 364 nm was used as the exciting light source. An exposure time is 30 seconds/point. As shown in FIG. 3, a peak of high intensity exists in the vicinity of a wavenumber of 600 cm⁻¹, and a peak of relatively low intensity exists in the vicinity of a wavenumber of 490 cm⁻¹. In LiCoO₂, lithium is reduced in the charging state. When x in the expression Li₁₋ₓCoO₂ becomes 0.25 or more, the crystal structure is significantly changed.

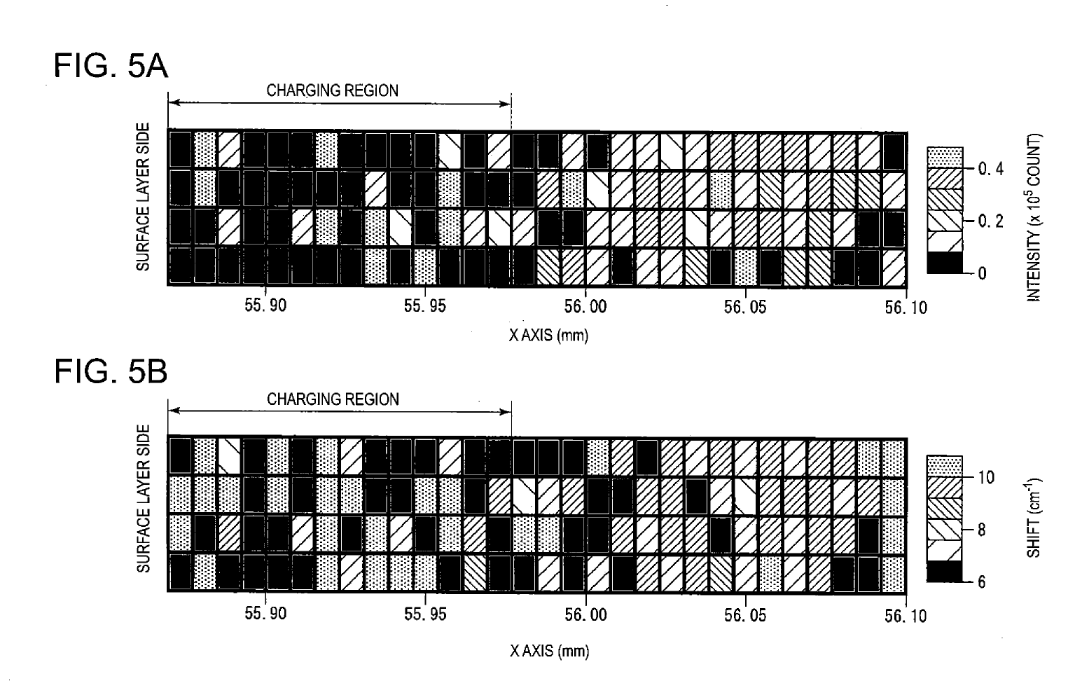

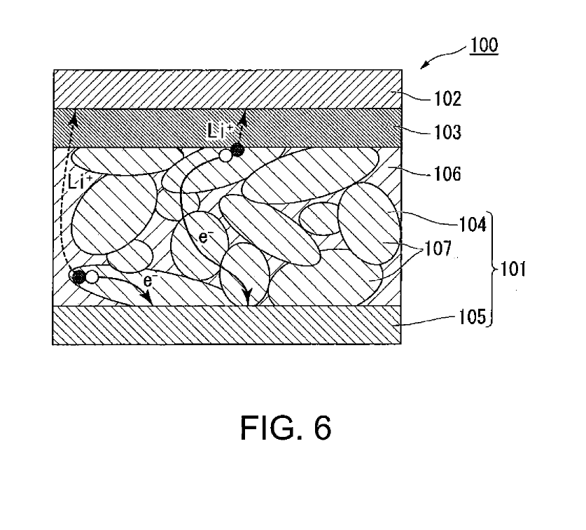

Since the intensity of the peak in the vicinity of a wavenumber of 600 cm⁻¹ is high, the peak is preferable for the Raman spectroscopic measurement. When LiCoO₂ is in the discharging state, the high peak appears at about 600 nm as shown in FIG. 4A. On the other hand, when lithium is reduced in the charging state, as shown in FIG. 4B, the peak shifts in a direction in which the wavenumber decreases, and the peak intensity is also reduced. Then, discrimination of the active material in the charging state or the discharging state can be performed by the intensity change of the peak or the shift of the wavenumber. Since the wavenumber can be converted into a wavelength or a frequency, the shift of the peak is not necessarily required to be expressed by the shift amount of the wavenumber, and can be expressed also by the shift amount of the wavelength or the shift amount of the frequency. The intensity of the peak is not changed only by the state (charging state or discharging state) of the active material, and there is a possibility that the intensity is influenced by the height difference of the section. If the discrimination of the state of the active material is performed based on the shift of the peak, the influence of the height difference of the section disappears, and therefore, this is preferable.

The Raman spectroscopic analysis of the section 24 is preferably performed at plural positions of the smooth section. The measurement positions preferably include plural positions different in distance (depth) from the surface layer. The measurement sequence is not particularly limited. The measurement may be performed in sequence from the positive electrode side to the negative electrode side, or the measurement may be performed in sequence from the negative electrode side to the positive electrode side. When measurement positions of two or more lines are set in the direction crossing the positive electrode and the negative electrode, the measurement position may be moved one line by one line, or the measurement position may be moved in the direction crossing the lines.

FIGS. 5A and 5B show an example of mapping results in which LiCoO₂ of a thickness of about 0.3 mm is used and the distribution of active material in the charging state or the discharging state is obtained. When the distribution of the active material in the charging state or the discharging state is visualized, the range of a utilization depth of active material can be visually and easily understood.

FIG. 5A shows an example of mapping obtained based on the change of the intensity. In the mapping, measurement points were set at 30 points in the direction crossing the positive electrode and the negative electrode and on four lines in parallel to each other, and the discrimination of the active material in the charging state or the discharging state was performed at 120 points of 30×4. In FIG. 5A, the direction crossing the positive electrode and the negative electrode was made a right and left direction, and the surface layer side, that is, the negative electrode side in the positive electrode active material body was arranged at the left side. As a result of the measurement, it is found that the charging region (that is, the contributing part 14a of FIG. 1) where the decrease of the peak intensity is large and the degree of decrease of lithium is large exists within the range of about 50 to 100 μm from the surface layer. Incidentally, some points where the peak intensity is high exist in a part of the charging region of FIG. 5A. These points can be interpreted such that the active material not contributing to charging and discharging exists in the part of the charging region by such a cause that the contact of active material crystal grains is insufficient.

FIG. 5B shows an example of mapping obtained based on the shift. In the mapping, measurement points were set at 30 points in the direction crossing the positive electrode and the negative electrode and on four lines in parallel to each other, and the discrimination of the active material in the charging state or the discharging state was performed at 120 points of 30×4. The value of the shift was obtained such that the wavenumber of the peak of LiCoO₂ in the discharging state was made a reference, and the amount of movement of the peak wavenumber to the small side was made the value. In FIG. 5B, the direction crossing the positive electrode and the negative electrode was made a right and left direction, and the surface layer side, that is, the negative electrode side of the positive electrode active material body was arranged at the left side. As a result of the measurement, it is understood that the charging region (that is, the contributing part 14a of FIG. 1) where the shift is large and the degree of decrease of lithium is large exists within the range of about 50 to 100 μm from the surface layer.

When the utilization depth of active material of the lithium secondary battery active material body is measured as described above, the lithium secondary battery active material body is processed so as to have the same thickness as the obtained utilization depth of active material. As a result, the lithium secondary battery active material body including the active material with the depth required for the function as the active material can be formed. In the lithium secondary battery active material body, the ratio of the active material contributing to the charging and discharging is high. Thus, the thickness of the lithium secondary battery active material body becomes almost equal to the utilization depth of active material, and the volume capacity density of the lithium secondary battery can be improved.

Even if the thickness of the lithium secondary battery active material body is smaller than the utilization depth of active material obtained by the measurement, there is no problem in that the volume capacity density is high. However, if the thickness is excessively small, it becomes difficult to secure the capacity. Then, the thickness of the lithium secondary battery active material body is preferably almost equal to the utilization depth of active material. For example, the thickness of the lithium secondary battery active material body is preferably within the range of 80 to 120% of the utilization depth of active material, and more preferably within the range of 90 to 110%.

Incidentally, the measurement method according to the invention is suitable when the utilization depth of active material is not larger than the thickness of the lithium secondary battery active material body used for the measurement. When the thickness of the lithium secondary battery active material body is smaller than the utilization depth of active material, the utilization depth of active material is preferably measured by using the active material molded body having a large thickness before the thickness of the lithium secondary battery active material body is reduced.

As described above, the transmission distance of lithium ions in the lithium secondary battery depends on not only the transmission distance of lithium ions diffusing in the lithium secondary battery active material body but also the transmission distance of lithium ions in the electrolyte. Then, the measurement of the utilization depth of active material is preferably performed in a condition close to a state where the lithium secondary battery active material body is used in the lithium secondary battery. For example, when an electrolyte is used in the lithium secondary battery, the same electrolyte is preferably used at the time of measurement of the utilization depth of active material.

In order to suppress deterioration of the lithium secondary battery active material body as the sample, the steps of the exposure of the section and the Raman spectroscopic analysis are preferably performed in an environment suitable for treatment of the lithium secondary battery active material body, such as an inert gas atmosphere in which the existing amount of moisture and oxygen gas is sufficiently reduced. When the lithium secondary battery active material body does not include a material having high activity, such as metal lithium, a very severe environment is not required to be prepared.

There is a possibility that the manufacturing condition (for example, molding method, sintering temperature, etc.) of the lithium secondary battery active material body influences the size of the active material crystal grain, the degree of sintering and the like. However, when the lithium secondary battery is manufactured, it is undesirable from the viewpoint of efficiency that the utilization depth of active material is individually measured for every lithium secondary battery active material body. Then, it is preferable that one or plural lithium secondary battery active material bodies are selected at random from lithium secondary battery active material bodies manufactured of the same materials and in the same manufacture conditions, the utilization depth of active material is obtained for the selected lithium secondary battery active material body, and the obtained utilization depth of active material is used for the optimization of the thickness of the lithium secondary battery active material body. When the utilization depth of active material is specified, and then, when the lithium secondary battery active material body is manufactured of the same material and in the same manufacturing condition, even if the measurement of the utilization depth of active material is not repeated, an expected purpose can be achieved by manufacturing the lithium secondary battery active material body having a specified thickness based on the previously obtained measured value.

In the lithium secondary battery according to the invention, the optimum thickness of the active material is evaluated by the measuring method according to the invention, and the active material with a volume exactly corresponding to the evaluated thickness can be installed. By this, since the active material does not include a volume not contributing to the charging and discharging (that is, the non-contributing part 14b of FIG. 1), the volume capacity density is improved. In the lithium secondary battery, the positive electrode and the negative electrode may have substantially flat shapes parallel to each other. When the positive electrode and the negative electrode are wound in a roll shape, the thickness of the active material sandwiched therebetween is made thin and is optimized. As a result, if the volume is not changed, the number of times of winding is increased and the capacity can be increased. If the capacity is not changed, the volume is reduced and miniaturization can be achieved.

As the active material, rare earth or noble metal is used in addition to lithium, and accordingly, the cost can be reduced and resources can be saved by reducing the use amount thereof .

Although the invention has been described on the basis of the preferable embodiments, the invention is not limited to the embodiments, but can be variously modified within a range not departing from the spirit of the invention.

The lithium secondary battery may be a metal lithium secondary battery using metal lithium, and may be a lithium ion secondary battery not using metal lithium. Uses of the lithium secondary battery are not particularly limited, and the lithium secondary battery can be widely used for a portable electronic equipment, a cellular phone, a smartphone, a camera, a watch, an electric tool, a hybrid vehicle battery, etc.

What is claimed is:

1. A measuring method of an utilization depth of active material, comprising:
cutting a lithium secondary battery active material body in a direction from a positive electrode to a negative electrode;
exposing a section;
smoothing the section;
performing a Raman spectroscopic analysis on the smooth section; and
measuring the utilization depth of active material of the lithium secondary battery active material body.

2. The measuring method of the utilization depth of active material according to claim 1, wherein the Raman spectroscopic analysis is performed at a plurality of positions of the smooth section to obtain a distribution of an active material in a charging state or a discharging state, and the utilization depth of active material is measured from the distribution.

3. The measuring method of the utilization depth of active material according to claim 1, wherein a smoothness of the smooth section is Ra<0.9 μm.

4. The measuring method of the utilization depth of active material according to claim 1, wherein discrimination of an active material in a charging state or a discharging state is performed based on a shift of a Raman scattering peak.

5. A manufacturing method of a lithium secondary battery, comprising:
measuring an utilization depth of active material of a lithium secondary battery active material body by a measuring method of an utilization depth of active material according to claim 1; and
forming the lithium secondary battery active material body including an active material with a depth required for a function as the active material.

6. A manufacturing method of a lithium secondary battery, comprising:
measuring an utilization depth of active material of a lithium secondary battery active material body by a measuring method of an utilization depth of active material according to claim 2; and
forming the lithium secondary battery active material body including an active material with a depth required for a function as the active material.

7. A manufacturing method of a lithium secondary battery, comprising:
measuring an utilization depth of active material of a lithium secondary battery active material body by a measuring method of an utilization depth of active material according to claim 3; and
forming the lithium secondary battery active material body including an active material with a depth required for a function as the active material.

8. A manufacturing method of a lithium secondary battery, comprising:
measuring an utilization depth of active material of a lithium secondary battery active material body by a measuring method of an utilization depth of active material according to claim 4; and
forming the lithium secondary battery active material body including an active material with a depth required for a function as the active material.

9. A lithium secondary battery manufactured by a manufacturing method of a lithium secondary battery according to claim 5.

10. A lithium secondary battery manufactured by a manufacturing method of a lithium secondary battery according to claim 6.

11. A lithium secondary battery manufactured by a manufacturing method of a lithium secondary battery according to claim 7.

12. A lithium secondary battery manufactured by a manufacturing method of a lithium secondary battery according to claim 8.

13. A lithium secondary battery, wherein a thickness of an active material is 80% or more of an utilization depth of active material measured by a Raman spectroscopic analysis.
